(19) United States
(12) Patent Application Publication
(10) Pub. No.: US 2004/0148450 A1
(43) Pub. Date: Jul. 29, 2004

(54) Serially connectable USB drive

(76) Inventors: Shih-Chang Chen, Taichuang (TW); Chien-Lei Hu, Taichuang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/351,393

(22) Filed: Jan. 27, 2003

(51) Int. Cl. G06F 13/20

(52) U.S. Cl. 710/313

(57) ABSTRACT

The present invention relates to a serially connectable USB drive. The USB drive has an upstream and a downstream port to facilitate the serial connection of other USB drives or the networking of other USB peripheral devices. The USB drive is equipped with a switch circuit. In the case that another serially connectable USB drive or a standard USB drive is inserted into the downstream port, the switch circuit executes the serial connection controlling function and connects the memories of both USB drives. In the case that a standard USB peripheral device is inserted, the switch circuit changes figuration into a USB HUB for the memories of USB drive and the USB peripheral device to communicate respectively with the computer mainframe or other microprocessor units.

### BACKGROUND OF THE INVENTION

1. Field of the Invention

The invention is about a universal serial bus (USB) drive, especially a storage device applicable to a USB interface. The USB drive has preserved a downstream port to facilitate serial connection of other USB drives or networking of other USB peripheral devices.

2. Description of Related Art

The internal function of a conventional USB drive is shown in FIG. 4, a USB interface 8 is connected with a flash memory 9. The data stored in the flash memory 9, via USB interface 8, communicate with the USB of the computer mainframe or other microprocessor units to complete data transmission.

Due to immature technique, the capacity of the early flash memory can't be expanded. Therefore the capacity of the early USB drive is quite limited. Nowadays, the technique for flash memory has been advanced and the multimedia information has been applied to varied areas. The capacity of the early USB drives is insufficient to save such a large multimedia file. The current method for a user to save a large file is to divide and save the file in different USB drives or other recording media through certain backup software. A user has to mark the order of storage of those USB drives. In the case when reading a file via reading equipment, it is necessary to insert and replace those USB drives respectively in accordance with the storage order. Apparently, this is an insufficient way to save a file. Therefore, larger capacity of a USB drive is needed for saving a large file. The user will have to repurchase a USB drive with a larger capacity. The old device will be discarded and leads to waste of memory resource. Therefore, it must be considered in the new USB drives to connect serially to expand the memory capacity to solve such an embarrassed problem. Because the USB devices are very convenient to use, most of the computer peripheral devices are joined in the USB family by applying the USB protocol interface. Currently, most of the standard computer mainframe has only two preserved USB sockets. In the case when one USB drive is plugged into one of the sockets, there will be only one USB socket left for other device to plug in. It will not be enough for other USB devices to use. Therefore, it is necessary to purchase one or several USB HUB for further expansion. This increases cost for a user and leads to inconvenience in use. Therefore, to keep at least the same number of USB ports for the computer mainframe is considered in the new USB drive.

### SUMMARY OF THE INVENTION

The primary object of the invention is to solve the above problem and provide a serially connectable USB drive having an upstream and a downstream port to facilitate serial connection of other USB drives or networking of other USB devices. The serially connectable USB drive is equipped with a switch circuit. In the case that a serially connectable USB drive or a standard USB drive can be plugged into the downstream port of the original serially connectable USB drive, the switch circuit executes the serial connection controlling function and connects the memories of both USB drives. In the case that a standard USB peripheral device is inserted, the switch circuit is to switch the loop figuration and perform the function as a USB Hub for the memories of the USB drive and the inserted USB peripheral device to communicate respectively with the computer mainframe or other microprocessor units.

The invention is to preserve a downstream port for the respective USB drives to connect unlimitedly and serially with the others and to expand the memory capacity. Each drive can be utilized individually as well. This creates the flexibility in use. In expansion of the memory capacity, the switch circuit executes the serial connection controlling function by the internal label order in the memory to perform the operation of data writing and reading and to form a virtual hard disc with large capacity. The user does not have to concern about the insertion order of the respective USB drives. The firmware of the respective USB drives will control the order of data storage. On the other hand, the switch circuit can be automatically switched into the function of USB HUB providing a method of hot plug to connect with any USB peripheral device.

Thus, the present invention is a practical and advanced product with infinite serially connectable function, application to conventional USB drives and an expanded memory, also with at least the same number of USB sockets left on the computer mainframe, and it is to this end that the present invention is directed.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of the present invention;

FIG. 2 is a block diagram of the present invention;

FIG. 3A is a flow chart of the use of the present invention in one state;

FIG. 3B is a flow chart of the use of the present invention in another state; and

FIG. 4 is a block diagram of a conventional USB drive.

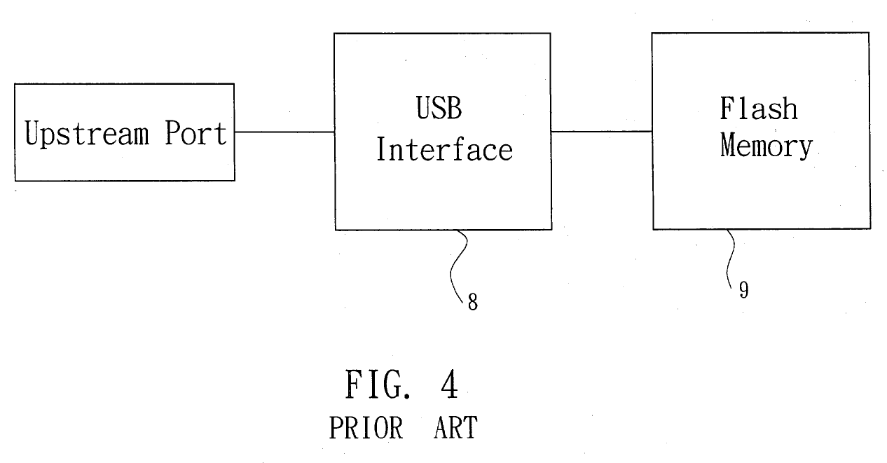

### DETAILED DESCRIPTION OF THE INVENTION

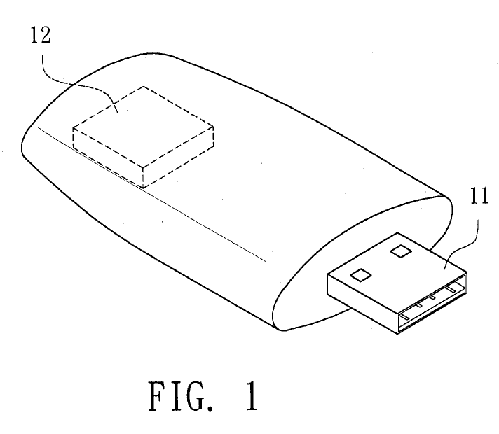

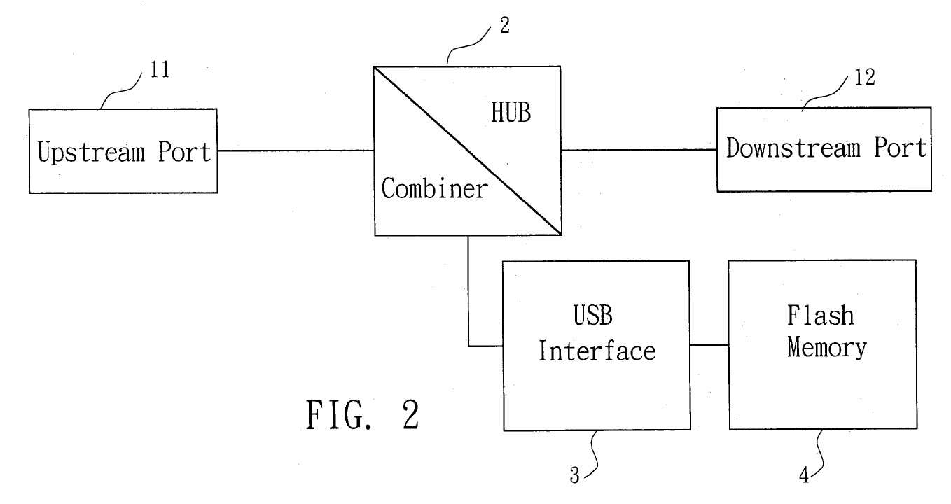

FIG. 1 shows the serially connectable USB drive of the present invention. FIG. 2 is a block diagram of the internal function that includes an upstream port 11, at least one downstream port 12 (which can be positioned on a lateral side or in any other position), a switch circuit 2, a USB interface circuit 3 and a flash memory 4.

The upstream port 11 is connected with a USB device or the socket of computer mainframe to form a topologic star network structure adopted by USB system. The downstream port 12 is adapted to be connected with USB peripheral devices or other USB drives. The USB drives of the present invention can be connected one after one for forming a virtual memory that is the summation of the connected USB drives.

The interface circuit 3 is connected with the switch circuit 2 and the flash memory 4 to transmit data by USB protocol.

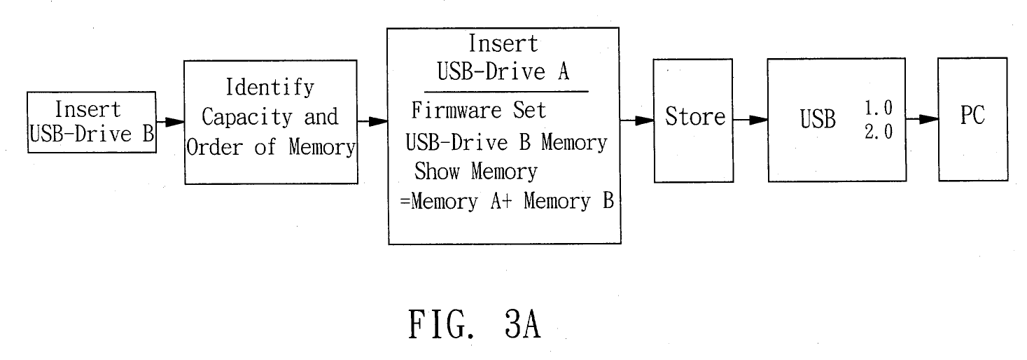

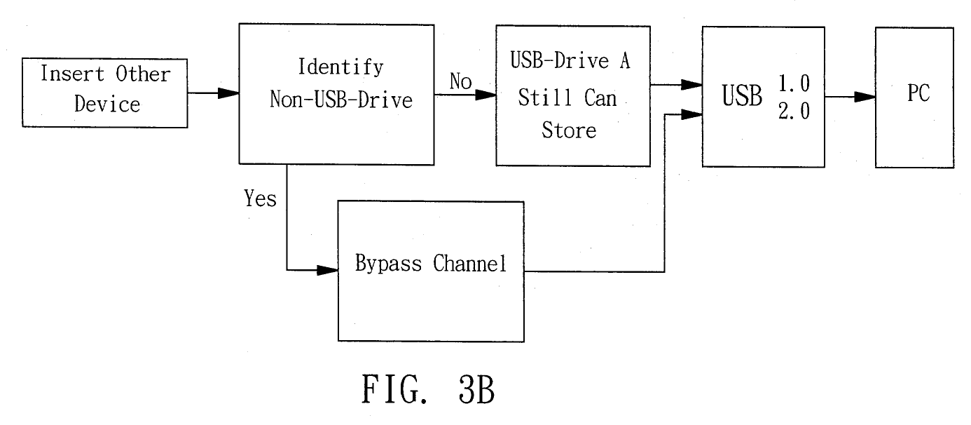

The switch circuit 2 is connected with the upstream port 11, the downstream port 12 and the USB interface circuit 3. The switch circuit 2 will change the loop figuration into a different function according to varied devices plugged into the downstream port 12, as shown in FIG. 3A and FIG. 3B. In the case that another serially connectable USB drive or a conventional USB drive with a compatible flash memory is inserted into the downstream port 12 and the switch circuit 2 executes the serial connection controlling function. The firmware of the switch circuit will identify the internal label in the flash memory of the inserted serially connectable USB drives. A new successive label is given to the non-label flash memory. The internal firmware in each drive will execute the operation of writing and reading of data storage in accordance with the label order. The data storage order is controlled to form a large single virtual storage space. Especially when the space of a flash memory is not enough for such a large multimedia file, the switch circuit will divide and save part of the large file in a substantial storage space of the flash memory in the other serially connectable USB drives of the present invention or the conventional USB drive. Therefore, a user can complete the data storage without worrying about the insertion order of the respective USB drives. A user does not have to, mark the storage order for those USB drives. In the case when reading a file via reading equipment, it is unnecessary to insert and replace those USB drives in accordance with the order of storage. Particularly, when two serially connectable USB drives are inserted in a different order than the one in the process of storage, the reading order will be decided for a divided file according to their label order of flash memory.

On the other hand, in the case that a standard USB peripheral device is inserted, switch circuit 2 switches the loop figuration and performs the function as a USB Hub for the inserted USB peripheral device to communicate respectively with the computer mainframe or other microprocessor units.

It is concluded that the present invention is convenient in use. The USB drive has preserved a downstream port 12 to serially connect with the other to expand the memory capacity. The USB drives of the present invention can be endlessly and successively connected to form a larger memory space. In expansion of the memory capacity, when the switch circuit 2 executes serial connection controlling function according to the internal label order of the flash memory 4, the operation of data reading and writing can be performed and form a virtual hard disc with a large capacity. A user does not have to worry about the insertion order of the respective USB drives. The firmware of the drive will control the order of data storage or flow direction. It is quite convenient. This function can be utilized to a parallel connection with several serially connectable USB drives as well as other conventional USB drives when multiple downstream ports are formed on the serially connectable USB drive of the present invention. Furthermore, each USB drive can be used individually as a small unit. On the other hand, according to the device inserted to the downstream port 12, the serially connectable USB drive of the present invention can be automatically switched into the function as a USB HUB and provide a hot plug to connect with any USB peripheral device. It is fairly convenient in use. Moreover, the last one of many USB drives connected successively still has the function to automatically switch into a USB HUB. The present invention is with great flexibility.

In conclusion, the design of the present invention is convenient in use. Each serially connectable USB drive can be used elastically. It increases the storage space and breaks the limitation of capacity of the flash memory, and furthermore, provides an alternative way to use the old discarded USB drive effectively. The present invention is a practical and advanced product.

Although the invention has been explained in relation to its preferred embodiment, it is to be understood that many other possible modifications and variations can be made without departing from the spirit and scope of the invention as hereinafter claimed.

What is claimed is:

1. A serially connectable USB drive comprising:
an upstream port, at least one downstream port, a switch circuit, a USB interface circuit and a memory device adapted to be connected to USB devices or a USB socket of a computer mainframe, wherein the upstream port is designed and adapted for being inserted into the USB devices or the USB socket of the computer mainframe;
the USB interface circuit designed for being connected with a switch circuit and a memory to process data transmission, the switch circuit designed for being connected with the upstream and downstream ports and a USB interface circuit to switch a loop figuration into different functions as followed;
according to varied USB devices selectively plugged into a downstream port of the serially connectable USB drive, thereby:
the switch circuit executes the serial connection controlling function and connects the memories of USB drives to form a virtual memory with an expanded capacity, the virtual memory having a size that is the summation of memories from the connected USB drives; and
a standard USB peripheral device is inserted, the switch circuit informing the computer mainframe or a USB Host Controller of other microprocessor units to switch the loop figuration and perform the function as an USB Hub for the memories of the connected USB drives and the inserted USB peripheral device to communicate respectively with the computer mainframe or other microprocessor units.

2. The serially connectable USB drive according to claim 1, wherein the memory is a flash memory compatible with that of the inserted USB drive.

3. The serially connectable USB drive according to claim 1, wherein the downstream port is designed and adapted for being connected with other USB peripheral devices.

4. The serially connectable USB drive according to claim 1, wherein the downstream port is designed and adapted for being connected with other USB drives.

5. The serially connectable USB drive according to claim 2, wherein the downstream port is inserted into another serially connectable USB drive, and the switch circuit comprises a firmware executing a serial connection controlling function to connect the memories of the connected drives and discriminating an internal label in the flash memory of the inserted serially connectable USB drive by the firmware such that a new label is given to a non-label flash memory and the internal firmware in each drive executes the operation of writing and reading of data storage in accordance with the label order.

6. The serially connectable USB drive according to claim 1, wherein the downstream port is adapted to being connected successively at least one serially connectable USB drive.

7. The serially connectable USB drive according to claim 5, wherein the adjacent serially connectable USB drives are connected to each other by its downstream ports.

8. The serially connectable USB drive according to claim 5, wherein the capacity of the flash memory is not enough for a storage file such that the switch circuit divides and saves part of the storage file in a substantial storage space of the flash memory in the connected USB drives.

9. A serially connectable USB drive comprising:
an upstream port, at least one downstream port, a switch circuit, a USB interface circuit and a memory device adapted to be connected to a USB device or a USB socket of a computer mainframe, wherein the upstream port is designed and adapted for being connected to the serially connectable USB device or a socket of a computer mainframe;
the downstream port adapted for being connected any USB peripheral device or the serially connectable USB drive or other USB drive; and
a USB interface circuit used for connecting switch circuit and a flash memory to transmit data, the switch circuit switching the loop figuration into different functions as followed:
according to varied USB devices plugged into the downstream port of serially connectable USB drives such that a standard USB peripheral device is inserted, the switch circuit informing the computer mainframe-or a USB Host Controller of other microprocessor units to switch the loop figuration and perform the function as an USB Hub for the memories of the connected USB drives and the inserted USB peripheral device to communicate respectively with the computer mainframe or other microprocessor units.

10. The serially connectable USB drive according to claim 9, wherein the upstream port is connected to the serially connectable USB device or a socket of the computer mainframe.

11 The serially connectable USB drive according to claim 9, wherein the flash memory is compatible with that of the connected USB drive(s) that is inserted into the serially connectable USB drive.

12. The serially connectable USB drive according to claim 9, wherein the capacity of the flash memory is not enough for a storage file such that the switch circuit divides and saves part of the storage file in the substantial storage space of the flash memory in the other USB drive which is inserted at the downstream port of the serially connectable USB drive.

13. The serially connectable USB drive according to claim 9, wherein the downstream port is adapted for being connected successively with at least one serially connectable USB drive.
